(19) United States
(12) Patent Application Publication
(10) Pub. No.: US 2022/0411160 A1
(43) Pub. Date: Dec. 29, 2022

(54) CARTON BOX EMBODIED WITH A SUPPORTING BASE

(71) Applicant: Pangiotis BILLIAS, Athens (GR)

(72) Inventor: Pangiotis BILLIAS, Athens (GR)

(21) Appl. No.: 17/752,442

(22) Filed: May 24, 2022

(30) Foreign Application Priority Data
Jun. 24, 2021 (GR) 20210100421

(51) Int. Cl. B65D 77/24; B65D 77/06

(52) U.S. Cl. CPC B65D 77/24; B65D 77/068

(57) ABSTRACT

The present invention relates to an efficient beverage container which may include a base which is removably attached on top of a beverage package in a carton. The base comprises of a top flat surface and a plurality of legs permanently integrated with the top flat surface. The top flat surface has a hole for passing through a handle provided on top of the carton. In use, the base may be removed from the carton and the carton may be placed on top of a table surface. The carton may be removed by pulling out the handle from the hole provided on the top surface of the base. The carton may have a tap towards the bottom edge to dispense the beverage contained in the carton into a receptacle like a mug, cup or a glass.

### CROSS-REFERENCE TO RELATED APPLICATION

This application claims priority to Greek patent application 20210100421 filed Jun. 24, 2021, the content of which are incorporated herein in the entirety by reference.

### FIELD OF THE DISCLOSURE

The invention relates to multipurpose beverage containers. More specifically, the invention relates to a bag in box embodying a supporting base for easy dispensing of a beverage in a receptacle like a glass.

### BACKGROUND OF THE DISCLOSURE

Background description includes information that may be useful in understanding the present invention. It is not an admission that any of the information provided herein is prior art or relevant to the presently claimed invention, or that any publication specifically or implicitly referenced is prior art.

Beverage containers often require an adequate supporting structure to hold the containers in place. The structures in form of bases are available for purchase in the market. Such bases are most often semi-permanent structures, the provision of which requires an additional cost and a separate search in order to find and purchase them.

When beverages packaged in bladders are used, a base is necessary so that dispensing in glasses or various receptacles through a dispensing mechanism in form of a tap can be facilitated, without having to hold the bladder by the hand during dispensing.

Various supporting structures for bulk beverage packaging have been proposed in the prior art. Although, assumably effective for their intended purposes, the existing devices and proposals come as an increased provision cost, a storage space is necessary when they are not in use and their form makes it difficult to encompass them in the available space. Moreover, not one size of base may be an appropriate fit for all beverage packaging.

Therefore, it would be desirable for an efficient beverage packaging that is user-friendly, economical, readily available and overcomes the limitations of the prior art.

### SUMMARY OF THE DISCLOSURE

Various objects, features, aspects and advantages of the inventive subject matter will become more apparent from the following detailed description of preferred embodiments, along with the accompanying drawing figures in which like numerals represent like components.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

The term beverages mean all liquid foods, such as wine, beer, beverages, soft drinks, juices, milk, water, olive oil, vinegar, etc.

Further aspects and advantages of the present invention will become apparent from the ensuing description which is given by way of example only.

An aspect of the present disclosures pertains to an efficient beverage container which may comprise a base which is provisioned to be removably attached on top of a beverage package in a carton. The base comprises of a top flat surface and a plurality of legs permanently integrated with the top flat surface. The top flat surface has a hole for passing through a handle provided on top of the carton. In use, the base may be removed from the carton and the carton may be placed on top of a table surface. The carton may be removed by pulling out the handle from the hole provided on the top surface of the base. The carton may have a tap towards the bottom edge to dispense the beverage contained in the carton into a receptacle like a mug, cup or a glass. In an aspect, the legs of the base may be independent from the top flat surface of the base and the legs may be assembled before using the base for holding the carton on top.

In an aspect, the legs of the base may be of a sufficient height so that the top flat surface is at a distance from the surface of the table to allow dispensing of beverage from the carton kept on the top flat surface, in a receptacle kept of the surface of the table.

In an aspect, the base is made of but not limited to, a recyclable packaging paperboard material, recyclable plastic material and/or a bamboo wood material.

Various objects, features, aspects and advantages of the inventive subject matter will become more apparent from the following detailed description of preferred embodiments, along with the accompanying drawing figures in which like numerals represent like components.

Within the scope of this application, it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments unless such features are incompatible.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a perspective view of a base, in accordance with embodiments of the present disclosure.

FIG. 2 illustrates a perspective view of a beverage packaging with the base mounted thereon, in accordance with embodiments of the present disclosure.

FIG. 3 illustrates an exemplary perspective view of the beverage packaging mounted on the base thereon, in accordance with embodiments of the present disclosure.

### DETAILED DESCRIPTION OF THE DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Various terms as used herein are shown below. To the extent a term used in a claim is not defined below, it should be given the broadest definition persons in the pertinent art have given that term as reflected in printed publications and issued patents at the time of filing.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The present disclosure relates to the field of multipurpose beverage containers. More specifically, the invention relates to a bag in box embodying a supporting base for easy dispensing of a beverage in a receptacle such as glass or cup.

An advantageous objective of the present disclosure is to provide a user-friendly beverage packaging carrying a bulk quantity of beverage embodying a supporting structure in form of a base which may be placed over a table-top and hold the beverage container on top of it enabling an easy dispending of the beverage from a dispensing mechanism into a receptacle.

Another advantageous objective of the present disclosure is to provide a beverage packaging which is eco-friendly being made or manufactured from eco-friendly and recyclable materials.

Another advantageous objective of the present disclosure is to provide a beverage packaging which is disposable and is integrated with a carton encompassing a bladder containing juice, beverage, alcoholic beverage, oil, vinegar, etc. The bases, according to the present invention, are characterized in that they are manufactured from recyclable paper and in sizes which allows them to be mounted as lids on bladder carton packages. Thereafter, the bases are removed and positioned on cupboards or tables. The cartons with the bladders are positioned on the bases in order to facilitate the dispensing of beverages. The size of the bases allows, due to the distance of the support surface of the bladders from the cupboard or the table, a glass or another receptacle to be positioned on the surface of the table, for receiving a beverage.

Embodiments explained herein relates to a multipurpose beverage container embodying a supporting structure which enables easy dispensing of the beverage from the container in a receptacle such as a glass or a cup.

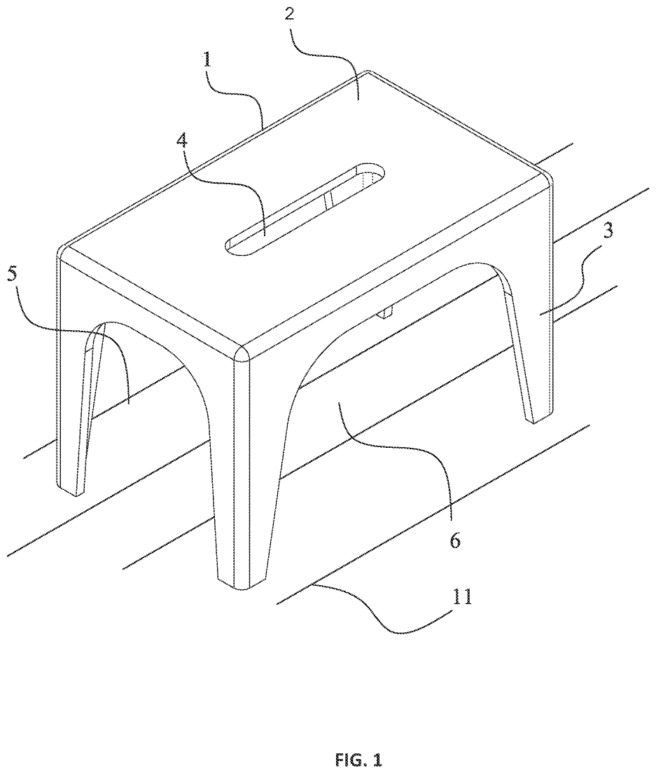

FIG. 1 illustrates a base (1) to be removably attached on top of a beverage package (not shown). The base (1) which consist of the legs (3) extending from a top flat surface (2) and forms two voids (6) and (5) on the sides of the base (1) and between the consecutive legs (3). The surface (2) has a hole (4) preferably in the center of the top surface (2). The hole (4) provides an access for a carrying handle from underneath. In an embodiment, the hole (4) may be suitably shaped to enable a carrying handle given on a top surface of the beverage package (not shown) to pass through from underneath the surface (2).

In an enabling embodiment, the legs (3) are of same height and enable the base (1) to stand upright on a flat surface such as a table-top or a ground (11). In one embodiment, the legs (3) may be integrated with the top surface (2) of the base (1). In one embodiment, the legs (3) may be assembled on the top surface (2) before the base is setup over a surface (11) for supporting the beverage packaging (7) on top. In one embodiment, the legs (3) may be attached to the beverage packaging (7) and attached to a slot provided on corner edges of the top surface (2) to assemble the legs (3) on the top surface (2).

In one embodiment, the legs (3) may be folded into the top surface (2) and may be opened to extend as legs (3) for supporting the beverage packaging (7) on top of the base (1).

In one embodiment, the legs (3) may be of sufficient height to raise the top surface of the base (1) above a surface of the table (11) in order to allow easy dispensing of the beverage contained in the beverage container (7) into a receptacle placed on the surface of the table (11).

In one embodiment, the height of the legs (3) may be adjustable to increase or decrease as required by proving but not limited to, extendable folds in the legs (3).

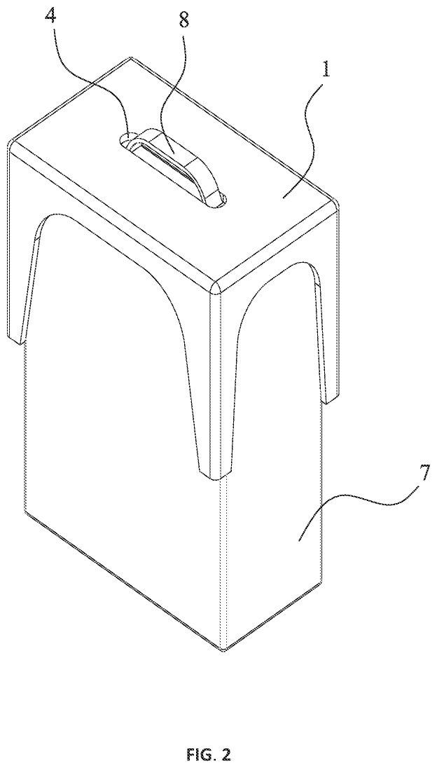

FIG. 2 illustrates a perspective view of a beverage packaging with the base (1) mounted thereon, in accordance with embodiments of the present disclosure. The base is removably mounted with its top surface snugly fitting on a top surface of the beverage packaging. The hole (4) provided on the center of the top surface (2) of the base (1) is shown to pass through a handle (8) from underneath. The handle (8) is attached to the top surface of the beverage packaging (7). In an exemplary enabling embodiment, the handle (8) allows transporting of the beverage package (7) with the base (1) mounted on as a single entity. In an embodiment, the legs (3) of the base are shaped to be curved and fit snugly on the sides of the beverage packaging (7).

In an embodiment, the beverage packaging (7) is, but not limited to, a bladder packaging. In an embodiment, the beverage packaging may be a bag in box to comprise a bladder bag containing a liquid encased in a rigid container box. In an embodiment, the bladder bag may be a collapsible bag made of a suitable material such as but not limited to, cellulose, metallized or coextruded materials, tin or compostable plastic, to safely hold a liquid or a semi-liquid beverage. In an embodiment, the bladder bag may be made of a suitable material such as but not limited to, insulated cellulose, metallized or coextruded materials to safely contain a hot or a cold beverage. In an embodiment, the rigid box containing the collapsible bag is made of but not limited to, corrugated fiberboard or cardboard.

In an embodiment, the beverage container may have a sealable inlet (not shown) through which the beverage is filled in the beverage container (7). In an embodiment, the beverage container may have a sealed yet openable outlet for dispensing of the beverage. In an embodiment, the outlet may be a tap opening allowing for a controlled dispensing of the beverage. In an embodiment, the base (1) may be sealably attached to the beverage container (7). In an embodiment, the seal may be break when the base (1) is detached from the beverage container depicting that the beverage container may have been tampered with or interfered with and may have been compromised in quality.

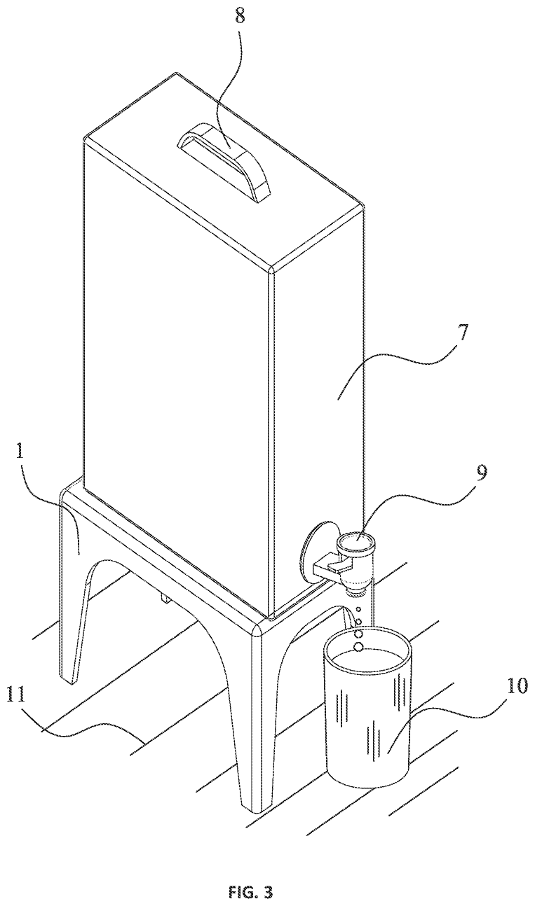

FIG. 3 illustrates an exemplary perspective view of the beverage packaging being detached from the base (1) and place on a top surface (2) of the base (1). The beverage package (7) may be pulled away to detach from the base (1).

In use, the beverage package (7) is positioned on top of the base (1) allowing dispensing of the beverage through a dispensing tap (9) into a receptacle (10) placed on the surface (11). In an embodiment, other dispensing mechanism known in the art may be provided. In an embodiment, the dispensing tap (9) is provided towards a bottom edge of the beverage package (7).

In an embodiment, the base (1) is manufactured from paperboard, recyclable plastic, wire or bamboo wood, and is disposable, has low cost, is recyclable and serves as a support for a beverage package until the emptying of the beverage contained in the beverage container (7).

In an embodiment, the base (1) may be of suitable size and shape to be mounted on the beverage package (7) snugly from the top. In an embodiment, the four legs (3) of the base (1) may extend on the sides of the beverage package (7) as shown in FIG. 2. In an embodiment, the four legs (3) of the base (1) may extend on the sides to the length of the beverage package (7) and provide support to the beverage package (7) as a whole. In an embodiment, the four legs (3) of the base (1) may slide onto complementary grooves provided on the edges of the beverage package (7).

In an embodiment, the paperboard portion between the legs (3) can be removed to form the voids (5), (6) between the legs (3). In an embodiment, it may be understood that the same effect can also be achieved without removing the lateral material between the legs (3). On the upper flat surface (2) of the base (1), as shown in FIG. 3, the bladder packaged in a carton (7) is positioned. The protruding tap (9) has a sufficient distance from the flat support surface (11) so that a glass (10) or another receptacle is positioned for receiving beverage contained in the bladder kept on the upper flat surface of the base (1). The handle (8) passes through the hole (4) on the top surface of the base (1) when positioned on the carton (7) (as shown in FIG. 2), thereby facilitating easy transport of the beverage packaging (7) with the base (1) as a single package or entity. In one embodiment, a bladder alone, without a carton package, may be positioned on the base (1).

In one embodiment, the beverage packaging (7) may be of shape but not limited to, trapezoidal, rectangular or cylindrical. The shape of the base (1) affixed on the top surface of the beverage packaging (7) is complementary to the shape of the beverage packaging (7) in order for the base (1) to be seated snugly on the beverage packaging (7).

The present invention shows an exemplary base and is not limited as regards the shape, size and manufacturing material. The manufacturing materials may be hard paper, packaging paperboard (nodule), recyclable plastic materials, wire or bamboo wood. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed:

1. A beverage container comprising: a base (1) removably attached on top of a beverage package in a carton (7), wherein the base (1) comprises of a top flat surface (2) and a plurality of legs (3) permanently integrated with the top flat surface (2), wherein the base (1) supports the carton (7) on top of a table surface, wherein the flat surface (2) has a hole (4) for passing through a handle (8) provided on top of the carton (7) and wherein the carton (7) having a protruding tap (9).

2. The beverage container according to claim 1, wherein the base (1) is removed from the carton (7) by pulling out the handle (8) from the hole (4) provided on top of the carton.

3. The beverage container according to claim 1, wherein the hole (4) is provided on a center of the top flat surface.

4. The beverage container according to claim 1, wherein the handle (8) is provided on a center of a top surface of the carton.

5. The beverage container according to claim 1, wherein the legs (3) are independent from the top flat surface (2) and are assemblable before use.

6. The beverage container according to claim 1, wherein the legs (3) have a sufficient height so that the top flat surface has a distance from a surface (11) to allow dispensing of a beverage from the carton (7) in a receptacle kept on the surface (11).

7. The beverage container according to claim 1, wherein the base is made of a recyclable packaging paperboard material.

8. The beverage container according to claim 1, wherein the base is made of a recyclable plastic material.

9. The beverage container according to claim 1, wherein the base is made of bamboo wood material.

10. The beverage container according to claim 1, wherein the carton is a bag in box.
